(19) United States
(12) Patent Application Publication
(10) Pub. No.: US 2025/0296068 A1
(43) Pub. Date: Sep. 25, 2025

(54) SHELL-AND-TUBE REACTOR AND HIGH-TEMPERATURE REDOX PROCESS

(71) Applicants: ENI S.P.A., Roma (IT); SYNHELION SA, Lugano (CH)

(72) Inventors: Aldo BOSETTI, Novara (IT); Carmen SAMA', Novara (IT); Massimo ZAMPATO, Venezia (IT); Luca MADIA, Venezia (IT)

(73) Assignees: ENI S.P.A., Roma (IT); SYNHELION SA, Lugano (CH)

(21) Appl. No.: 18/862,296

(22) PCT Filed: May 5, 2023
(86) PCT No.: PCT/IB2023/054680

§ 371 Date: Nov. 1, 2024

(30) Foreign Application Priority Data
May 5, 2022 (IT) 102022000009257

(51) Int. Cl. B01J 19/24; B01J 19/00; B01J 23/10; C01B 3/38; C01B 32/40

(52) U.S. Cl. CPC B01J 19/2425; B01J 19/0053; B01J 23/10; C01B 3/38; C01B 32/40; B01J 2219/00099; C01B 2203/0283; C01B 2203/1041

(57) ABSTRACT

There is a high-temperature tube bundle reactor built from material derived from metal oxides such as alumina-zirconia. The heat exchange surfaces of the reactor have a specific surface finish, and the bulk matrix of the material of the various components of the reactor has a specific grain, pore size and porosity characteristics. There is also a high-temperature redox process using the reactor.

### CROSS-REFERENCE TO RELATED APPLICATIONS

This application claims priority from PC application No. PCT/IB2023/054680 filed on May 5, 2023, which claims priority from Patent Application claims priority from Italian Patent Application No. 102022000009257 filed on May 5, 2022, the entire disclosures of which are incorporated herein by reference.

### FIELD OF THE DISCLOSURE

The present disclosure relates to the realization of a shell and tube reactor optimized to operate at high temperature and carry out thermochemical reactions that take place by absorption or heat transfer for the conversion of raw materials into final products. In particular, the tube bundle reactor subject-matter of the present disclosure is suited to exchange heat coming from a solar field, typically concentrated solar field, with a reagent system capable of carrying out chemical transformation processes using renewable energy. The reagent system is a set formed by substances capable of reacting, alone or in the presence of other substances, and/or a solid system, catalytic or not, at temperatures higher than 600° C.

### DESCRIPTION OF THE RELATED ART

Thermochemical reactions have as their main limiting factor the efficiency of the exchange of heat between the energy source and the reagent system. The higher the exchange efficiency between the heat transfer fluid and the reagent system, the better the reaction results. Since some thermochemical reactions occur predominantly in high temperature ranges (e.g., above 600° C.), improving the efficiency of the heat exchange between heat source and reagent system implies the need to develop technical solutions that allow the maximization of the heat exchange. A practical example of a high-temperature thermochemical reaction is one wherein the heat source is represented by a heat transfer fluid heated through solar energy by means of concentrated solar plants. The technological capacity of making high-temperature thermochemical reactions possible allows the adoption of new renewable energy sources such as, for example, concentrated solar plants. The use of renewable energy also makes it possible to reduce or eliminate greenhouse gas emissions compared to the use of energy from fossil sources. One of the most studied renewable sources in this field is solar energy through the use of concentrated solar technologies.

The concentrated solar (CSP) technology allows to concentrate in a predefined area (receiver) the solar radiation hitting on a high reflecting surface. In this way a high flow of solar energy can be obtained in the receiver with the consequent possibility of reaching high temperatures, up to 2000° C. This solar thermal energy can be used for various purposes, for example to generate electrical energy. One of the most studied uses for concentrated solar energy is to promote endothermic reactions, i.e. reactions that require an external supply of heat to occur. To do this, two main methodologies are known: 1) make the desired reaction occur directly in the receiver by directly heating the reagents by exposing them to the flow of reflected and concentrated solar rays (direct solar reaction), 2) use the receiver to heat a fluid, called heat transfer fluid, which in turn heats the reagent system in an appropriate area and mode (indirect solar reaction). The indirect solar reaction has the advantage that, by modulating the flow of the heat transfer fluid (generally in the gas phase given the temperatures involved), the reaction temperature can be better managed in order to maximize yields and to have the possibility of using a part of the heat of the receiver to carry out a thermal storage. Thermal storage (TES) allows to have a heat resource to exploit when the solar heat is not present or available, for example at night or in weather conditions not favourable to insolation. In this way, a continuous heat flow can be ensured permitting thermochemical processes to operate continuously over 24 hours, avoiding shutdowns and restarts with a consequent decrease in the energy efficiencies and hourly productivity. The solution with indirect solar reaction needs to develop a dedicated reactor, where the heat transfer fluid effectively exchanges heat with the reagent system and allows the reagents to be in the best conditions to synthesize the desired products. The first system, i.e. a directly heated reactor, has a limit in its development: the amount of reagent material that can be brought to the desired temperature is limited by the surface of the reactor itself, unless huge reactors are used. Many solar reactors, both direct and indirect, have been proposed and developed in the past few years (see e.g. Energies, 11, 2358, 2018; doi: 10.3390/en11092358).

Most direct solar reactors are actually an integral part of the receiver with the following major issues.

There is an inherent difficulty in controlling the reaction temperature. The efficacy of the solar field derives from natural insolation with consequent higher temperature around the middle hours of the day and which is lower at sunrise and sunset.

Maintaining a constant temperature reaction (a normal requirement in order to have a constant yield of the products avoiding conversion variations with consequent increase of the downstream treatment systems) becomes not easy to carry out, with the need for any energy supplies from a non-solar source at certain times or for cooling at others. In addition, direct solar heating leads to non-uniform heating of the reagent material with possible temperature gradients between the irradiated part and the underlying layers, this phenomenon is accentuated when carrying out oxidation reactions that are exothermic in nature. The surface part of the reagent material, which reacts as first, would heat up more than the underlying one not yet involved in the reaction.

It is also complex to manage the energy flows coming from solar source with a consequent lower efficiency in carrying out reactions continuously over 24 hours. The exploitation of solar energy for a possible storage would involve either a second receiver or a heat exchanger with a fluid in addition to the reactor with greater increase of operation and costs.

In the case of a direct solar reaction, the reactor-receiver is necessarily located at the point of concentration of the solar rays. In a tower concentrated field this involves the installation and the management of a complex system at the top of a solar tower with consequent problems due to its height and the reduced space available. If CSP (Concentrated Solar Power) field is formed by parabolic disk solar concentrators, the reactive system becomes not unique but multiplied by the number of concentrator systems that increases the costs of the solar field due to the need to move reagents and products in a not small number of reactors.

The approach to the indirect solar reaction instead implies that the solar field concentrates the energy in a receiver by heating a heat transfer fluid with high efficiency. This heat transfer fluid can be sent partly to a reactor, where a thermochemical synthesis takes place, and partly towards a thermal storage system, or other system, to enhance its energy content (for example to create useful electrical energy within the process set-up of which the solar reactor is a part like pumps, compressors, controls, recovery systems, etc.). The overall thermal efficiency of the process is minimally reduced due to losses along the transport lines of the heat transfer fluid and to the non-quantitative yield of heat transfer among the various parts. However, the technology based on the indirect solar reaction allows to work continuously with more operational options and with greater flexibility. For example, it is no longer required to use a reactor having quartz windows through which to make the sun rays pass (the windows usually reduce robustness and therefore safety in working under temperature and pressure) or a reactor with a higher surface/volume cavity where to converge the sun rays. The reactor for indirect solar reaction allows to better control the temperature at which the reaction takes place, optimizing yields and thus avoiding g all the problems listed above related to direct heating.

The prior art proposes as a valid technology the use of a reactor heated with solar energy through a High-Temperature (HTF) heat transfer fluid. One of the easiest to use heat transfer fluids (HTF) that allows high thermal efficiencies as it has a high capacity to absorb energy both by direct irradiation and by radiation is water or mixtures of water and CO₂.

One application of particular interest, which exploits CSP technology with indirect solar reaction, is to produce methanol as a solar fuel from methane/carbon dioxide/water or hydrogen from water/methane. One of the major contributions to the greenhouse effect derives from carbon dioxide and its significant increase in the atmosphere is the subject of actions and goals at the international level. In an attempt to manage and minimize the production of CO₂ from anthropogenic activities, in recent years an attempt has been made to use the same carbon dioxide where it is produced, avoiding, for example, flaring in oil fields. Many efforts have been made in recent years to develop processes that convert CO₂ into other products or into energy carriers, for example into methanol for use in motor vehicles or as a solvent or reagent. It should be remembered that methanol, compared to petrol, has a higher octane number, burns more easily and has a higher latent heat of evaporation. For these reasons, greater energy efficiency of the engine and a reduction in gaseous emissions (HC, NOx) can be obtained from its use. Unfortunately, the high thermodynamic stability of carbon dioxide entails a consequent high energy in order to be able to transform it into other products. The chemical transformation into syngas, a mixture of CO and H₂, is one of the most studied ways in order to be able to produce methanol. Industrially, syngas is synthesized primarily from fossil sources of natural gas or coal via steam reforming, combined steam reforming, catalytic and non-catalytic partial oxidation. In order to be able to produce syngas from carbon dioxide, it is important to have an abundant and inexpensive energy source available in order to carry out the endothermic reactions of CO₂ valorisation. Taking in account its renewable characteristic, then the concentrated solar power becomes the preferred choice. In this perspective, a pathway of thermochemical transformation of carbon dioxide and water based on a metal oxide MO is being developed that performs a two-stage redox cycle as shown in the following diagram:

Reduction: MOox→MOred+O₂ (endothermic)

Oxidation: MOred+CO₂→MOox+CO (exothermic)

MOred+H₂O→MOox+H₂ (exothermic)

The redox cycle of the oxide is formed by:
thermal reduction of the metal oxide at high temperatures with oxygen release;
oxidation of the reduced metal at lower temperatures by carbon dioxide and water with consequent production of syngas.

In this way, by carrying out reduction and oxidation cycles in series, it is possible to produce syngas for application purposes.

In order to be able to take advantage of the solar heat contained in the HTF it is necessary that this exchanges with the substances to be heated inside a reactor. This reactor should conceptually allow:
a) the HTF fluid to heat the reagent material, for example a cerium oxide (called ceria), so as to warm it and keep it at the reaction temperature, carrying out this action continuously over time;
b) to contain the heated redox material making it react with the continuous flow of reducing and oxidizing substances, remaining intact both to the effect of temperature and pressure (gases are used and their use under pressure definitely optimizes the process because it allows to reduce the volumes involved and to overcome any pressure losses in the distribution and connection pipes) and to the reagents and products of the synthesis reaction (CO, H₂, CO₂, O₂, H₂O, CH₄) under the operating conditions used;
c) efficient heat exchange between the HTF heat transfer fluid and the reagent material to maximize yields and energy efficiencies;
d) to minimize thermal losses due to irradiation and conduction.

The ideal configuration for a reactor based on indirect solar reaction comprises a shell wherein the heat transfer fluid (HTF) flows and a tube bundle wherein the desired thermochemical reaction takes place.

When the design temperatures are lower than 700° C., according to the teachings of the prior art, a tube bundle reactor can be built using special metal alloys (e.g. Inconel 601), maintaining adequate resistance characteristics of the material a as the temperature rises. When the design temperatures of the tube bundle reactor exceed 700° C., the problems related to the high temperature and to the deterioration of the mechanical performance of the building materials make it extremely difficult, almost impossible, to design a tube bundle reactor, as the design temperatures approach 1500° C. The prior art is in fact unsatisfactory in the teachings relating to the realization of tube bundle heat exchange equipment with temperatures higher than 700° C., especially when the reagents and the reaction products comprise substances having oxidizing activity such as for example water or oxygen.

When the design temperatures exceed 700° C., it is known to use ceramic materials that have intrinsic characteristics that lead them to better withstand the exposure to extremely high temperatures. Two broad categories of ceramic materials can be distinguished: oxide-based ceramic materials and non-oxide-based ceramic materials. The first ones include alumina and zirconia, the second ones include silicon carbide (SiC). In case of having to operate at high temperatures (for example temperatures higher than 700° C.) and at the same time in the presence of fluids with oxidizing activity, the use of special steels, Ni, Cr and Mo based alloys must be excluded (apart from the tolerance to temperature, they are oxidized in the short/medium period, manifesting structural problems); also many ceramic materials, in particular non-oxide based ceramics such as SiC, compatible with high temperatures but not resistant to oxidizing agents, especially in terms of “environmental corrosion cracking” or even manifesting sublimation phenomena, must be avoided. In addition, since the tube bundle reactor is functional to obtaining the maximum heat exchange efficiency between heat transfer fluid (HTF) and the fluid inside the tube bundle, some ceramic materials are poorly suited to heat exchange. Ceramic materials known per se for use at temperatures higher than 700° C. include alumina (aluminium oxide Al₂O₃) and zirconia (zirconium oxide ZrO₂).

Alumina is resistant to oxidation but has a low thermal conductivity promoting its use to limit thermal dispersions but reduces, in terms of principle, the possibility of using it for applications wherein the maximization of heat exchange is a fundamental requirement; in fact, as we will see later, the contribution of convection, conduction and irradiation to the heat exchange mechanism are dependent on the temperatures involved and, beyond temperatures in the order of 600° C., the transmission of heat by irradiation becomes preponderant with respect to the transmission by conduction. Therefore, the low thermal conductivity of alumina is no longer a limiting factor for heat exchange efficiency at temperatures above 700° C. Alumina, however, is relatively fragile, exhibiting modest fracture resistance and therefore tends to form cracks that might lead to structural damage to the reactor.

Silicon carbide (Sic) does not have the limit of modest heat transfer by inherent conduction of alumina. This type of material may seem suitable for the realization of a tube bundle reactor. Having in mind to realize a high-temperature shell and tube reactor that treats fluids containing oxidizing agents, silicon carbide, however, manifests microporosities that do not make it suitable for the safe containment of oxidizing fluids with possible leaks, especially under conditions of pressure above the environmental one. Moreover, although normally indicated as resistant to oxidizing agents, the microporosity effects reported in the literature indicate that the resistance of the SiC to the oxidizing agents is effective for short periods and not for prolonged contacts such as those necessary in a continuous thermochemical process like the one of an indirect solar radiation reactor. (see Ceramics International 42 (2016) 1916-1925, http://dx.doi.org/10.1016/j.ceramint.2015.09.161 and Ceramics International 42 (2016) 4679-4689; http://dx.doi.org/10.1016/j.ceramint.2015.11.117).

Furthermore, in SiC, especially at temperatures greater than 700° C., sublimation, pitting and environmental corrosion cracking effects can occur which make it unfit for use in a high-temperature tube bundle reactor.

### SUMMARY OF THE DISCLOSURE

Aim of the present disclosure is to realize a tube bundle reactor that overcomes the drawbacks of the prior art and allows to operate at very high temperatures in the range from 600° C. to 1800° C., even in the presence of oxidizing agents circulating inside the reactor. In particular, the reactor subject-matter of the present disclosure is particularly suitable for use in concentrated solar plants based on indirect radiation technology. In fact, in this type of plants, a heat transfer fluid (HTF) is heated by means of the concentrated solar radiation and represents the heat carrier that releases heat in the reactor to promote the thermochemical reaction inside the shell and tube reactor.

The present disclosure also relates to a redox process at high temperature ranging from 600° C. to 1800° C.

In the contest of the present disclosure the pressure values are measured in bar gauge (barg), a unit of measurement representing the difference between the pressure in bar in space and the atmospheric pressure in bar.

In the contest of the present disclosure, a mixture of metal oxides means both a mixture containing only alumina and zirconia and a mixture comprising alumina, zirconia and other elements, in particular a mixture of alumina-zirconia metal oxides that is toughened with yttrium oxide or magnesium oxide.

According to the present disclosure, there has been realized a tube bundle reactor whose building material is a mixture of alumina-zirconia metal oxides. As usual in the sector, building material of a shell-and-tube reactor means the material with which at least the main parts of the reactor are made, i.e. shell-and-tube reactor. The use of this material makes it possible to combine the advantages of alumina and zirconia in order to guarantee adequate mechanical resistance of the reactor at temperatures ranging from 600° C. to 1800° C. and good resistance to the action of oxidizing agents during continuous operation. The shell and tube reactor according to the present disclosure is therefore based on the use of a mixture of metal oxides, alumina/zirconia, which is preferably toughened with yttrium oxide or magnesium oxide according to known techniques allowing to exploit the properties of the individual components while minimizing the defects thereof. The addition of zirconia to alumina, giving rise to a material known as Zirconia-toughened alumina (ZTA), along with the toughening with yttrium oxide or magnesium oxide, makes the material much less brittle and suitable for being processed into the desired forms. This type of ZTA composite material, thanks to its low conductivity, makes it possible to contain heat inside the reactor reducing the energy losses to the outside. The reactor of the present disclosure is further characterized by a specific surface finish for the heat exchange surfaces so as to maximize the heat-transmitting radiative component that is predominant when the temperatures rise in the range from 600° C. to 1800° C. (e.g., at the temperature of 1000° C., the heat transmission by irradiation in a ZTA material is about 10 times higher than the transmission by conduction). As described below, also a specific characterization of the bulk component (material matrix) of the mixture of metal oxides, i.e. the definition of porosity, grain dimension and pore diameter of the ZTA material matrix, contributes to the improvement of the heat exchange, minimizing heat losses where necessary. The discovery of this possibility is based on laboratory experimentation carried out on specific specimens of alumina-zirconia (ZTA) material suitably processed and characterized together with a modelling study of heat exchanges.

The present disclosure also relates to a high-temperature redox process in the presence of oxidizing agents as described below.

### BRIEF DESCRIPTION OF THE DRAWINGS

The features and advantages of the present invention will become clear from the following description of a non-limiting example thereof with reference to the figures of the accompanying drawings, wherein:

FIG. 1 is a simplified view of a shell-and-tube reactor with parts removed for the sake of clarity;

FIG. 2 is a graph showing the relationship between diffuse reflectance and wavelength in the results of the tests carried out on sintered alumina-zirconia (ZTA), with the same surface processing;

FIG. 3 is a graph showing the relationship between diffuse reflectance and wavelength in the results of the tests carried out on the sintered alumina-zirconia (ZTA) as the surface finish and particle size of the matrix change;

FIG. 4 is a graph showing the relationship between emissivity and temperature in the results of the tests carried out on the sintered alumina-zirconia (ZTA) changing the surface finish;

FIG. 5 is a graph representing the evolution of emissivity as a function of temperature for various types of materials;

FIG. 6 represents a simplified view of an infinitely long cylinder with some characteristic dimensions;

FIG. 7 is a graph representing the trend of the absorption coefficient in relation to the wavelength for the superheated water vapour at 1200 K and 10 bar.

### DETAILED DESCRIPTION OF THE DISCLOSURE

In order to fully show the gist of the present disclosure, it is necessary to define how the heat transmission mechanism occurs between two bodies, with particular attention to the radiative component. Heat transmission between two bodies is known to take place by conduction, convection and irradiation. Each material, in consideration of the geometries and temperatures involved, is characterized by a specific ability to exchange heat through these mechanisms. However, it is important to remember that, as the temperature increases, the incidence of the heat transmission mechanism by conduction and convection decreases drastically in favour of the heat exchange component by irradiation. At temperatures higher than 600° C. the component of heat exchange by irradiation becomes predominant thus dictating the rules for the design of efficient exchange systems (see Thermal Radiation Heat Transfer, John R. Howell, M. Pinar Mengüç, Kyle Daun, and Robert Siegel). For these reasons we will analyse in more detail the mechanism of heat transmission by irradiation at high temperature, in particular defining how both the surfaces and the “bulk” (the matrix itself of the material) of a material contribute to the radiative heat exchange.

The transfer of energy by irradiation is described by the equation of the interaction of the electromagnetic waves with the materials. When an electromagnetic wave interacts with a surface between two different media, in accordance with the law of conservation of energy, we have:

$${ρ}_{r} + {ρ}_{d} + α + {τ}_{r} + {τ}_{d} = 1$$

where:
τᵣ is the direct transmittance.
ρᵣ is the direct reflectance or specular reflectance.
τ_{d} is the diffuse transmittance
ρ_{d} is the diffuse reflectance.
α is the absorbance or linear absorption coefficient

Diffuse reflectance od is defined by the ratio of the incident energy coming from the first medium to the energy dispersed in the half-plane of the first medium, integrated in the solid angle 2π (half-sphere of the first medium).

Diffuse transmittance ta is defined by the ratio of the incident energy from the first medium to the energy dispersed in the half-plane of the second medium, after having crossed the surface between the two media, integrated in the solid angle 2π (half-sphere of the second medium).

The sum σₛ=ρ_{d}+τ_{d} is defined as the surface scattering factor, where the surface scattering phenomenon is considered as any deviation of the propagation direction from the direction defined by Snell's law.

The total surface reflectance is equal to the sum of the direct and diffuse components ρ=ρ_{d}+ρᵣ, while the total surface transmittance is equal to the sum of the diffuse and direct component τ=τ_{d}+τᵣ. The energy balance relationship is thus sometimes summarised as:

$$ρ + α + τ = 1$$

As mentioned above, also the characteristics of the material matrix, the “bulk”, contribute to the radiative transmission of the heat; in fact, in addition to the surface properties of the surface between the first and second medium, there are characteristics, typically “bulk”, which define the behaviour of the second medium in terms of absorption and scattering by means of the coefficient α (linear absorption or absorbance coefficient) and σ (linear scattering coefficient), not to be confused with the surface scattering coefficient σₛ relative to the sum of the diffuse transmittance and reflectance of a surface. The sum of the linear scattering coefficient with the linear absorption coefficient, is defined as linear attenuation coefficient κ, which falls within Lambert-Beer's law:

$$\frac{I}{{I}_{0}} = exp ( - ( {τ}_{d} + {τ}_{r} ) l ) = exp ( - ( κ ) l )$$

$$where$$

$$K = α + σ$$

The distance l=5/(α+σ) is defined as the depth of penetration into the second medium; if the thickness of the second medium exceeds this value, t the medium can be substantially considered opaque with attenuation greater than 99%.

Emissivity ϵ is equal to the ratio between the energy emitted as thermal radiation of a wavelength defined by the surface temperature of a medium, according to Stefan-Boltzmann and Planck's law, and the corresponding analogous energy emitted by a black body placed at the same surface temperature. A black body is an idealized body that absorbs the entire incident electromagnetic radiation, regardless of its wavelength and angle of incidence. It is essential to emphasize that a “black body” emits radiation, contrary to what the name might imply, but emits it at a wavelength well defined by its temperature, whereas it absorbs that of any wavelength hitting on its surface. Furthermore, the black body is an “ideal diffuser” as the emitted radiation is isotropically irradiated.

The behaviours described here are also manifested when the irradiation passes through gases, media wherein scattering, absorption, etc. occurs, said gases are defined as “participating media”. If the behaviours of the gas in the medium do not depend on the wavelength of the radiation, it is called a “grey gas” model.

In general, the behaviour of the radiation in the passage from a first medium having refractive index n₁ to a second non-homogeneous medium having refractive index n₂ depends not only on the properties of the separation surface between the two media but also on the “bulk” properties of the second medium; in fact, if the radiation transmitted in the second medium is further reflected/refracted and/or subject to scattering within the second medium itself, the effects have an impact on the first medium. These effects manifest themselves when the second medium has the properties of a translucent medium (i.e. one that partially allows radiation to pass through) but are greatly simplified if, on the contrary, it can be considered “opaque”, i.e. with τ=0 as the energy balance relationship is reduced to ρ+α=1. In fact, by Kirchoff's law ϵ=α and thus the energy balance can also be written as ϵ=1−ρ.

In consideration of what has been exposed above, we now look at how the “bulk” radiative effects (i.e. linked to the matrix of the material) contribute to the heat exchange by irradiation when the dimension of the grains, pores and porosity change.

In a porous medium such as the mixture of alumina-zirconia oxides (ZTA) linear scattering is correlated to the grain of the particles of the material and the pore dimensions. Particles of material start from sub-micrometric sizes up to micrometric sizes. Since the radiation involved in the phenomenon relative to the temperature range of 700-1500° C. and approximately micrometric (2.5≥1.5 μm), the linear scattering phenomenon can only be partially modelled as Rayleigh scattering; a more precise modelling can be obtained by Mie scattering.

As anticipated, the linear scattering coefficient σ and the linear absorption coefficient α contribute to determining the linear attenuation coefficient κ. It is possible to define a kind of radiative conductivity Λ_{rad}, (Ref. “Thermal radiation heat transfer”—Howell, Siegel, Menguc), completely similar to that defined in Fourier's law of heat transmission equal to:

$${Λ}_{rad} = \frac{16}{3} \frac{σ {BoltzT}^{3}}{κ} \qquad ( 1 )$$

where σBoltz represents the Boltzman constant, which results in a strong advantage in the transmission of heat by radiation due to the increase in temperature, but also to the reduction of the linear attenuation coefficient κ.

The trend of the value of κ can be inferred with Kubelka-Munk's theory of diffuse reflection, complemented by the evaluation of Mie scattering.

In a translucent medium such as alumina-zirconia (ZTA), wherein a part of the radiation penetrates beyond the interface surface among media to a depth equal to l=5/(α+σ), the coefficient κ decreases, increasing the depth of radiation penetration with:
a) the increase in the dimensions of the ceramic particles;
b) with the decrease in porosity;
c) with the increase in pore dimensions.

The relationship between the linear absorption coefficient and the linear scattering coefficient, in an optically often medium is governed by the relationship:

$$\frac{σ}{α} = \frac{4 {ρ}_{d}}{{( 1 - {ρ}_{d} )}^{2}}$$

where ρ_{d} is the diffuse reflectance of the medium.

For ρ_{d} close to 1, as can be found in the alumina-zirconia (ZTA) samples that were tested, the share of the linear scattering coefficient with respect to the linear absorption coefficient that together make up the linear attenuation coefficient is preponderant and depends on the pore and particle dimensions, as well as on porosity.

Since the linear absorption coefficient α is linked to the linear attenuation coefficient κ and coincides with the emissivity of the medium by Kirchoff's law, it follows that, regarding the bulk properties of the ZTA, the emissivity ϵ follows the same trend as the linear attenuation of the medium due to scattering.

TABLE 1
Relationship between radiative characteristics
vs bulk properties of ZTA

| | | |
|---|---|---|
| Effects due to | ZTA grain | ZTA |
| bulk scattering | Pore Diameter | porosity |

| | | | |
|---|---|---|---|
| Emissivity (ε) | ↓ | ↑ | ↓ |
| Linear attenuation | ↓ | ↑ | ↓ |
| coeff. (κ) | | | |

As summarized in Table 1 above, with reference to an alumina-zirconia (ZTA) material, it is possible to note how the characteristics of the material matrix (“bulk”) influence the radiative properties of the material itself; in particular, an increase in the average diameter of the grains and/or the average diameter of the pores leads to a decrease in the emissivity and in the linear attenuation coefficient. A decrease in the porosity of the material also contributes to a decrease in the emissivity and in the linear attenuation coefficient.

These trends were experimentally verified on samples of sintered alumina-zirconia (ZTA).

In particular, two types of alumina-zirconia 80/20 (ZTA) were tested wherein the powder, before sintering, was treated with a 0.176 μm sieve. The first type of alumina-zirconia (ZTA) was obtained by sintering the powder passed through the sieve, while the second type was obtained by sintering the powder remained on the sieve.

FIG. 2 reports the graph of the diffuse reflectance with respect to the wavelength, obtained by laboratory measurements carried out with a spectrophotometer equipped with the accessory described in ASTM E 1331 standard. Based on the results of these measurements carried out on sintered alumina-zirconia (ZTA), obtained by isostatic pressing, it can be noted that in the tested ZTA the diffuse reflectance, with the same surface processing, increases with the fineness of the grain, due to the increase in the phenomenon of bulk scattering.

Consequently, the share of emissivity of the ZTA linked to bulk scattering also increases.

Let us now look at how the surface radiative effects contribute to the heat exchange by irradiation as the surface finish changes.

In literature (ref. “Thermal radiation heat transfer”—Howell, Siegel, Menguc) it is known from Drude and Davis theory for a conductive medium, that the emissivity of the surface of the medium increases with increasing roughness, expressed by its roughness parameter Γ, when the ratio between the wavelength of the radiation λ and the roughness is such that: 0.2<r/λ<1. In fact, when the wavelength rises above the value of 5 times the roughness, the surface has almost exclusively specular reflection and very small surface scattering. Since emissivity in an opaque metallic medium is equal to ϵ=1−ρ, if the surface exhibits strong specularity characteristics, the emissivity tends to 0. If, on the other hand, the wavelength falls below the roughness value, there is almost exclusively surface scattering, in the domain of the radiation propagation in the ray-tracing regime, then the Snell reflection tends to cancel out and therefore the emissivity increases, leading to values close to 1. (Ref. “Modeling the effects of surface roughness on the emissivity of aluminum alloys”, Chang-Da Wen, Issam Mudawar, “International Journal of Heat and Mass Transfer”, 2006). In the contest of the present disclosure, the surface roughness values described below refer (even when not explicitly indicated) to the roughness standard Ra as per average knowledge of the person skilled in the art; the roughness values according to roughness Ra are defined as the arithmetic average value of the deviations (taken in absolute value) of the actual profile of the surface with respect to the average line. The reference to surface roughness values according to the roughness standard Ra represents the normal approach to the definition of surface roughness according to common general knowledge (when a roughness is indicated without further clarification it is in fact commonly understood the roughness Ra). In addition, surface roughness values measured according to the Ra standard are also evident in the previously cited document “Modeling the effects of surface roughness on the emissivity of aluminum alloys”, Chang-Da Wen, Issam Mudawar, “International Journal of Heat and Mass Transfer”, 2006.

Similar considerations for porous and especially not completely opaque but translucent dielectric media like a mixture of ZTA metal oxides, wherein the penetration depth of the radiation in the medium reaches the value of a few millimetres, are not available in the literature.

For this purpose, samples of alumina-zirconia (ZTA) material with a different surface finish have therefore been made in order to analyse whether, as the surface processing of the material varies, the emissivity characteristics can be influenced, which, in turn, may depend on the roughness. The results of this experimentation are very useful for defining the surface processing characteristics of the various parts of the tube bundle reactor subject-matter of the disclosure.

Two series of samples of 80/20 alumina-zirconia (ZTA) material were then prepared, the first series with lapped (polished) surfaces (roughness of 0.1 μm) and the second series with surfaces treated with FEPA 180 abrasive grade “raw” paper, before sintering, therefore capable of producing surface roughness of the order of 80 μm (rough). It should be reminded that the radiation mainly involved in the phenomenon in the range 700-1500° C. is approximately micrometric (2.5÷1.5 μm), from the Planck relationship.

It is important to point out that the diffuse reflectance due to bulk scattering phenomena is directly correlated with emissivity, as we have seen above, as it is in turn correlated with the absorbance α through the linear attenuation coefficient κ and, by Kirchoff's law, with emissivity ϵ. In the case of diffuse reflectance linked to the surface finish, on the contrary, the diffuse reflectance increases when the specular reflection is reduced, therefore when roughness increases. Therefore, it is reasonable to expect that, like what happens with the metals (from literature), the diffuse reflectance and thus the emissivity will increase with increasing roughness.

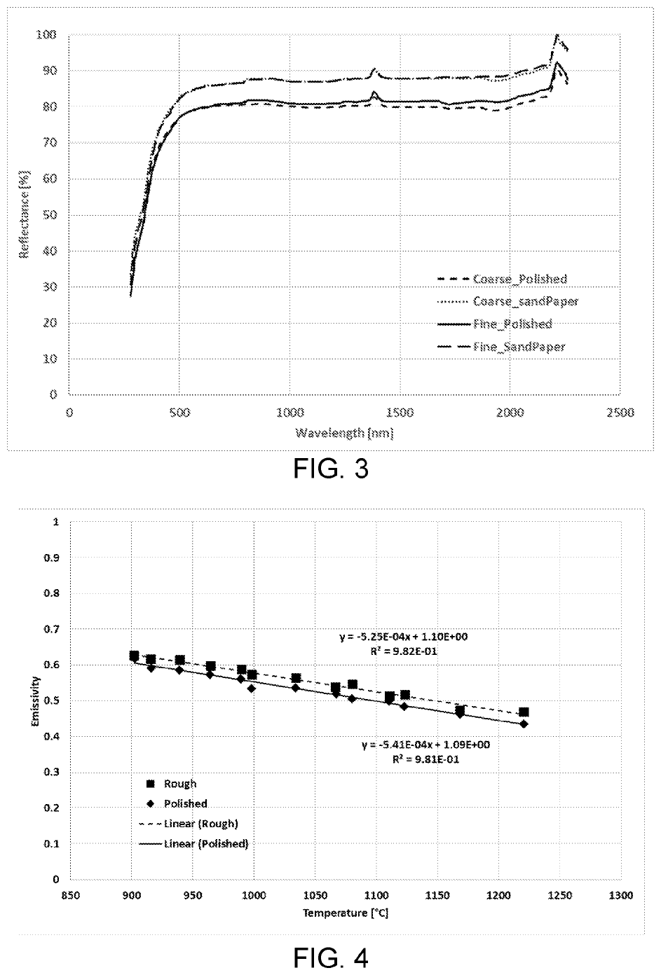

This expected trend, for mixtures of alumina-zirconia metal oxides (ZTA), is confirmed by the experimental results shown in FIG. 3, wherein the diffuse reflectance is lower for the lapped (polished) surfaces, also confirming the trend of FIG. 2 with regard to the dimension of the grain, the overall result of diffuse reflectance being due to the overlap of the bulk effects and surface effects.

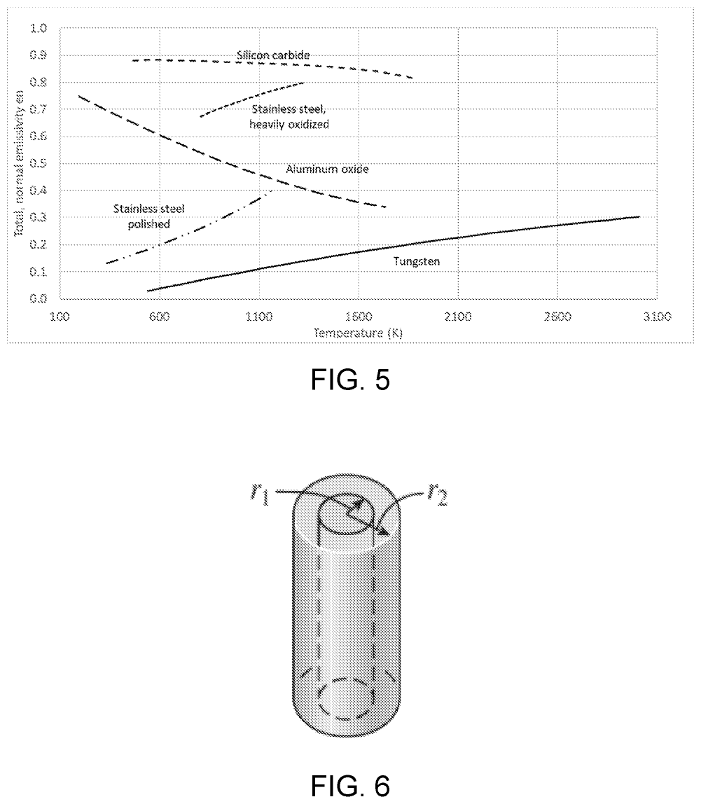

In conclusion, to confirm that what was obtained for the diffuse reflectance could be translated to emissivity ϵ, a useful parameter for the characterisation of reactor-specific heat transmission properties, emissivity measurements were carried out on the ZTA material samples using a thermal imaging camera at a temperature of 900-1200° C. The result of these measurements is reported in FIG. 4, which confirms the conclusions about an increase in emissivity even for translucent dielectric ceramic materials, such as alumina-zirconia (ZTA), in the presence of surface roughness above the wavelength scale involved and is in line with what is theoretically expected for alumina in FIG. 5.

Summarizing the above, Table 2 shows the contributions to the overall radiative effects of the different “bulk” and surface (roughness) parameters for alumina-zirconia (ZTA).

TABLE 2
Relationship between overall radiative characteristics
vs material properties and surface processing

| Overall | | ZTA grain | ZTA | ZTA |
|---|---|---|---|---|
| radiative effects | | Pore Diameter | porosity | roughness |
| Emissivity (ε) | ↓ | ↑ | ↓ | ↓ |
| Linear attenuation | ↓ | ↑ | ↓ | — |
| (κ) | | | | |

Previously, a relationship was reported that identifies the conductivity equivalent to the radiation of a medium expressed in terms of bulk property as the linear attenuation coefficient κ.

The radiative properties of the medium useful for the realization of the tube bundle reactor of the present disclosure remain to be determined, depending on the surface processing of the walls of the shell side and the tube side.

It is known in the literature (“Heat and mass transfer fundamentals and applications”—Yunus A. Cengel, Afshin J. Ghajar) the relationship that allows to determine the properties of heat transfer by radiation between two surfaces or between a surface and a medium defined as “participating” in the theory of heat transfer by radiation, that is a medium such as a gas that, at the working temperature, turns out to be active in terms of radiation emission according to the Stefan-Boltzmann law, with a trend proportional to the temperature at the fourth power and that presents a linear attenuation coefficient to radiation that satisfies the Lambert-Beer law.

The relationships are obtained by solving the problem of the Radiation Transfer Equation (RTE) in terms of J radiance, which makes heat transfer manageable by equivalence with an “electrical grid”:

$$\frac{q}{A} = \frac{{E}_{b} - {J}_{d}}{\frac{1 - ϵ}{ϵ}}$$

where E_{b} and J_{d} play the role of potentials and

$$\frac{1 - ϵ}{ϵ}$$

the role of a surface radiation resistor.

By combining this equation with the one relative to the surface of another medium or a “participating medium” such as a gas, the effect of heat transfer by radiation and the overall resistance between the two media are obtained.

In the case of an infinitely long cylinder such as the one of FIG. 6, as some parts of the reactor can be modelled in the first approximation, the relationship that determines the irradiation resistance between the inner and outer cylinders is as follows:

$${R}_{1 \to 2} = \frac{1}{{ϵ}_{1}} + \frac{1 - {ϵ}_{2}}{{ϵ}_{2}} \frac{{r}_{1}}{{r}_{2}} \qquad ( 2 )$$

### Where:

R_{1→2} is the irradiation resistance
r₁ is the radius of the inner cylinder
r₂ is the radius of the outer cylinder
ε₁ is the emissivity of the inner cylinder.
ε₂ is the emissivity of the outer cylinder
   that in the case of equal radii, that is, of directly facing media (e.g. a gas with a ceramic wall), it is reduced to:

$$R = \frac{1}{{ϵ}_{1}} + \frac{1}{{ϵ}_{2}} - 1 \qquad ( 3 )$$

As we will see later, particular combinations of surface finish, grain, pore diameter and bulk matrix porosity of the material of the components of the tube bundle reactor can achieve an unexpected improvement in the capacity of heat exchange by irradiation especially at high temperatures ranging from 600° C. to 1800° C.

In the contest of the present invention, with regard to a mixture of alumina-zirconia metal oxides (ZTA), the following is therefore defined:
a surface is considered lapped or polished when its surface roughness ranges from 0.01 μm to 1 μm;
a surface is considered with coarse finish when its surface roughness ranges from 10 μm to 250 μm;
a bulk structure is considered coarse-grained when it has an average grain diameter greater than 2 μm
a bulk structure is considered fine-grained when it has an average grain diameter lower than 2 μm
a bulk structure is considered to have large diameter pores when they have an average diameter greater than 0.2 μm
a bulk structure is considered to have small diameter pores when they have an average diameter lower than 0.2 μm
a bulk structure is considered at high porosity when it is greater than 0.5%
a bulk structure is considered at low porosity when it is lower than 0.5%

On the basis of what has been exposed so far and in consideration of the properties obtained experimentally for the alumina-zirconia (ZTA) used for the realization of the reactor, some useful characteristics can be identified for the construction of a tube bundle reactor for high temperatures which are aimed at:
maximizing heat transmission between the circulating heat transfer fluid on the shell side and the circulating fluid on the tube side;
maximizing heat transmission between the outer walls of the tube side and the inner walls of the tube side;
maximizing heat transmission between the inner wall of the tube side and the reaction fluid circulating therein;
minimizing heat transmission between the circulating heat transfer fluid on the shell side and the inner wall of the shell side;
minimizing heat transmission between the inner wall of the shell side and the outer wall of the shell side;
minimizing heat transmission between the outer wall of the shell side and the insulation material outside the reactor.

In consideration of the fact that:
the characteristics that distinguish the radiative properties of the media and of the surface processing of translucent media have been defined;
the properties of the fluids involved in the reaction have been defined;
the fluids involved in the reaction act as “participating media”;
the inner walls of the tube side, by isotropy, are at the same temperature;
the outer walls of the tube side are, for convective transport of the heat transfer fluid, substantially at the same temperature as the inner walls of the shell side;
   the desired characteristics for the alumina-zirconia (ZTA) material of the tube side of the tube bundle reactor are:
the inner and outer wall of the tubes having high emissivity which implies a high emissivity value of the tube side for the relationship (3), hence that:
   the surface of the tubes is as specular as possible and with high roughness, therefore with a coarse finish
the bulk structure of the tube side is (in order to maximize emissivity) fine-grained (small average grain diameter), with small average pore diameter and high porosity
the bulk structure of the tube side has a low linear attenuation coefficient, according to relationship (1), hence that:
   the bulk structure of the tube side is coarse-grained (large average grain diameter), with large pore diameter and low porosity

The characteristics of the bulk structure of the tube side appear to be in contrast depending on whether one moves to the direction of emissivity maximization or linear attenuation coefficient reduction. However, the benefit of the bulk structure of the tube side, only with regard to the emissivity properties due to the bulk itself are modest compared to the advantage obtained from (1) on the increase in the value of Λ_{rad} of bulk conductivity at radiation. Therefore, it is preferable to choose in the bulk structure configuration the tube side compatible with the decrease in the linear attenuation coefficient i.e.: coarse grain (large average grain diameter), large pore diameter and low porosity.

Similarly to what has been defined for the tube side of the shell-and-tube reactor, the desired characteristics for the alumina-zirconia (ZTA) material of the shell side of the reactor are:
the inner and outer wall of the shell having low emissivity, which implies a low emissivity value of the shell for (3), hence that:
   the surface of the shell is lapped (polished) and made as specular as possible
the bulk structure of the shell side is (in order to minimize emissivity) coarse-grained (large average grain diameter), with large average pore diameter and low porosity
the bulk structure of the shell side has a high linear attenuation coefficient for (1), hence that:
   the bulk structure of the shell side is fine-grained (small average grain diameter), with small average pore diameter and high porosity

Also for the shell side, like for the tube side, the characteristics of the bulk structure appear to be in contrast depending on whether one moves to the direction of emissivity minimization or increase of the linear attenuation coefficient. However, the benefit of the bulk structure linked to the lowering of emissivity exclusively due to the bulk itself is modest compared to the advantage obtained from (1) on the reduction of the value of Λ_{rad} of bulk conductivity at radiation. Therefore, even in this case, it is preferable to choose the bulk structure configuration of the shell side compatible with the increase in the linear attenuation coefficient, namely: fine grain (small average grain diameter), with small average pore diameter and high porosity.

By way of example of the combined advantages obtainable from the construction of a tubular reactor with the characteristics indicated above, the gap between the shell side and the tube side of the reactor was modelled by means of a HITRAN commercial software package, calculating the absorption coefficient of the heat transfer fluid (HTF). For the purposes of this modelling it has been assumed that the heat transfer fluid (HTF) is superheated water vapour at a temperature of 1300 K and 10 bar and the material is 80/20 alumina-zirconia.

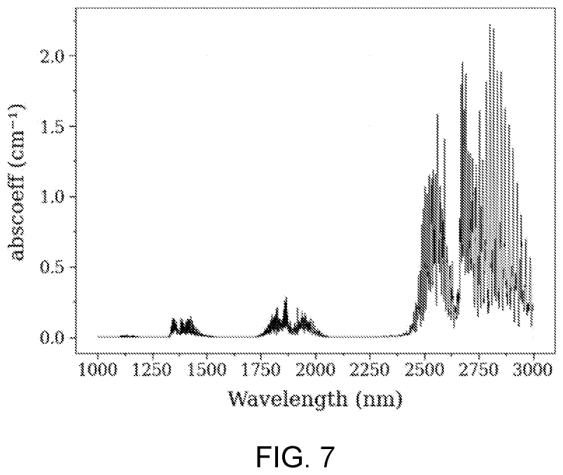

With reference to FIG. 7, it is evident that the heat transfer fluid (HTF) behaves as a participating and thick medium since its transparency, in many regions of the spectrum of interest, is exhausted after a few centimetres of penetration. In addition, as known from literature, the emissivity of water vapour about 1200 K and 10 bar ranges from 0.12 to 0.15. Under these conditions, an evaluation using the relationship (3), considering the two cylinders “internal” and “external” (internal the water vapour, external the ZTA alumina-zirconia shell) of equal radius, allows to define the sensitivity of the transmission of heat by radiation with respect to the type of surface processing of the shell side. In particular, the emissivity of alumina-zirconia (ZTA) moves from 0.49 (surface with lapped finish) to 0.51 (surface with coarse finish). Using the relationship (3), therefore, a reduction of the heat transmitted by the gas to the shell side equal to 1% is obtained. Similarly, the refractory insulation installed outside the shell side of the reactor has an emissivity ranging from 0.65 to 0.9, with the higher values obtained with refractory/insulating materials, engineered to have high emissivity. Using (3), therefore, a reduction of the heat transmitted from the shell side to the outer insulator ranging from 3% to 4% is obtained under conditions of surface with lapped finish of the alumina-zirconia ZTA.

Using the same evaluation methodology with regard to the tube side and considering that for the tube side the transmission of the heat from the heat transfer fluid (HTF) must be maximized, an improvement by about 1% is obtained using coarse-finished surfaces.

As regards the interior of the tubes, assuming that the fluid circulating in them is, for example, a mixture of CH₄+CO₂+H₂O, the emissivity of the mixture at the temperature and pressure considered (1300 K, 10 bar) is approximately equal to that of the superheated water vapour, i.e. approximately 0.1. In addition, depending on the diameter the of tubes, the circulating fluid (such as a mixture of CH₄+CO₂+H₂O) can be thick or thin, for the latter condition being the improvement negligible (substantially transparent fluid). From the literature data, if the tubes have a diameter lower than 2 cm, the absorption coefficient is such that the mixture of the gases mentioned (CH₄+CO₂+H₂O) is opaque to radiation; therefore, the improvement obtained with the processing indicated for the inner surface of the tubes is around 1%.

A further improvement of the efficiency of the radiative heat exchange inside the tubular reactor is obtained by using specific bulk characteristics of the alumina-zirconia matrix (grain diameter, porosity and pore diameter); these affect the linear scattering coefficient of the material, manifested by the different diffuse reflectance (see FIG. 3), as already shown above. In fact, the linear scattering coefficient is directly correlated to the linear attenuation coefficient by means of the relationship (1), and acts in terms inversely proportional to the radiation transmission. From the experimental tests on alumina-zirconia (ZTA) (see FIG. 3) a value of 0.80 is obtained for coarse-grained alumina-zirconia, while a value of around 0.82 is obtained for fine-grained alumina-zirconia. An evaluation carried out with these values allows to establish an efficiency improvement by about 2.5% both for the shell side and for the tube side.

Considering all the contributions listed so far, the overall improvement in the efficiency of transmission of the heat by radiation obtained by a tubular reactor realized with the characteristics described above is around 11-12%.

A solution of this type, based on the values detected experimentally by the samples of alumina-zirconia (ZTA) made and tested in the laboratory, allows to have a more favourable thermal balance in the operating conditions with economic advantages and lower operational management costs quantifiable in the same percentage range identified for the overall improvement of the exchange efficiency.

For reasons linked to the technological and cost difficulty in obtaining alumina-zirconia specimens, the tests and the experimentation discussed above were carried out with 80/20 alumina-zirconia specimens. This definition is universally recognized and known in the sector and represents, in general terms, the amount of alumina and that of zirconia present as a percentage in the mixture of metal oxides that define the material. Although direct experimentation was therefore carried out with 80/20 alumina-zirconia specimens, it is plausible to expect similar behaviour with respect to the characteristics of transmission of the heat by radiation for other mixtures of alumina-zirconia metal oxides (ZTA), as well.

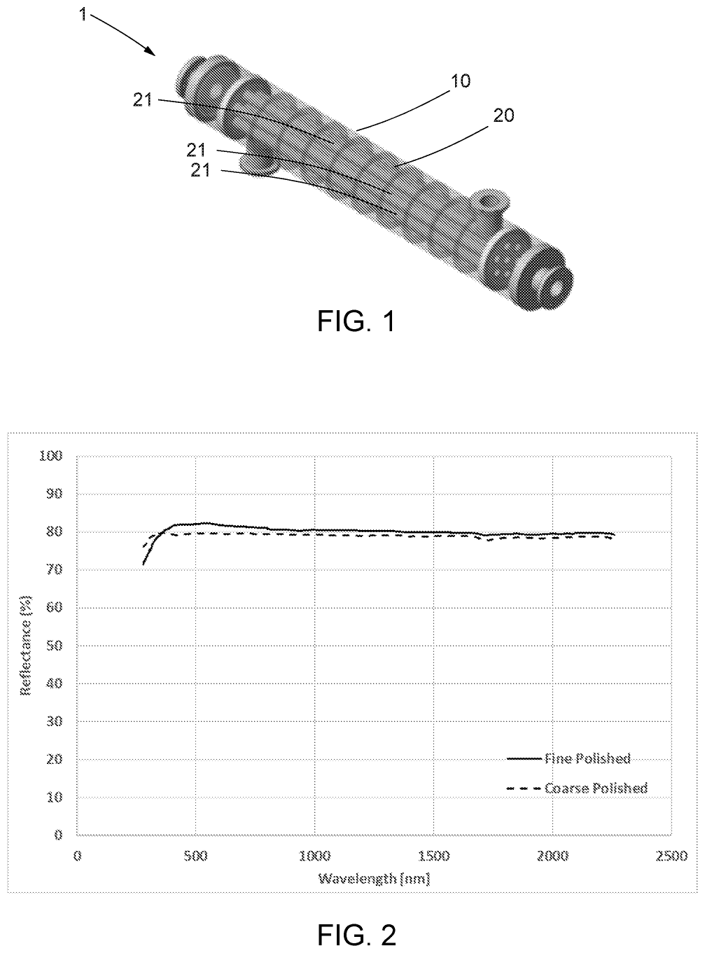

In consideration of what has been exposed above, the disclosure therefore relates, according to FIG. 1, to a shell-and-tube reactor 1 suited to be used at temperatures ranging from 600° C. to 1800° C., comprising a plurality of tubes 21 and a shell 10, for the heat exchange between a first heat transfer fluid circulating on the shell side and a second fluid circulating on the tube side, the reactor being characterized in that:
the building material is a mixture of alumina-zirconia ZTA metal oxides;
the outer surface of the shell side has a surface roughness ranging from 0.01 μm to 1 μm;
the inner surface of the shell side has a surface roughness ranging from 0.01 μm to 1 μm;
the material of the shell side has an average grain diameter ranging from 0.15 μm to 10 μm, an average porosity ranging from 0.01% to 5% and an average pore diameter ranging from 10 nm to 0.2 μm.

In a preferred embodiment the reactor 1, as described above, has the following characteristics:
the outer surface of the shell side has a surface roughness ranging from 0.05 μm to 0.5 μm;
the inner surface of the shell side has a surface roughness ranging from 0.05 μm to 0.5 μm;
the material of the shell side has an average grain diameter ranging from 0.3 μm to 5 μm, an average porosity ranging from 0.01% to 0.5% and an average pore diameter ranging from 50 nm to 0.1 μm;

The characterization of the bulk matrix and the surface processing of the material for the shell side of the shell-and-tube reactor 1 increases the efficiency of the radiative contribution of heat exchange between the heat transfer fluid (HTF) and the fluid circulating in the tubes 21 and minimizes losses of heat with respect to the external environment.

As anticipated, the combination of particular characteristics of the matrix of the material and of the surface finish of both the shell and the tube side 21 achieves a further unexpected advantage in the overall heat exchange efficiency within the reactor 1.

In a further preferred embodiment of the disclosure, the reactor 1, as described above, has the following characteristics:
the outer surface of the tubes 21 has a surface roughness ranging from 10 μm to 250 μm;
the inner surface of the tubes 21 has a surface roughness ranging from 10 μm to 250 μm;
the material of the tube side has an average grain diameter ranging from 0.01 μm to 0.5 μm, an average porosity ranging from 0.01% to 5% and an average pore diameter ranging from 0.1 μm to 10 μm.

In a further preferred embodiment of the disclosure, the reactor 1, as described above, has the following characteristics:
the outer surface of the tubes 21 has a surface roughness ranging from 40 μm to 120 μm;
the inner surface of the tubes 21 has a surface roughness ranging from 40 μm to 120 μm;
the material of the tube side has an average grain diameter from 0.05 μm to 0.25 μm, an average porosity ranging from 0.01% to 0.5% and an average pore diameter ranging from 0.2 μm to 2 μm.

In particular, the alumina-zirconia (ZTA) that can be used for the construction of the reactor 1 subject-matter of the disclosure is a mixture of alumina-zirconia metal oxides with weight percentages ranging from 95/5 to 70/30.

Thus, in a further preferred embodiment of the disclosure as described above the building material of the reactor 1 is a mixture of alumina-zirconia ZTA metal oxides with weight percentages ranging from 95/5 to 70/30.

In consideration of the fact that the reactor 1 subject-matter of the present disclosure can be installed inside a concentrated solar plant, using as heat transfer fluid (HTF) the one coming directly from heating by means of solar collectors, the temperatures of the carrier fluid can reach extremely high values.

For these reasons, in a further preferred embodiment of the disclosure the reactor 1, as described above, has a maximum design temperature ranging from 600° C. to 1800° C.

It is known that the materials comprising a mixture of metal oxides such as alumina and zirconia, commonly also referred to as ceramic materials, (obtained by sintering process) exhibit mechanical strength and toughness properties that are often unsatisfactory for industrial uses or for obtaining complex artefacts. For these reasons, the process for toughening these materials by means of yttrium oxide or magnesium oxide is known. The toughened alumina-zirconia has mechanical strength and toughness that are definitely superior to the starting material, also allowing processings by means of machine tools that are difficult to perform on the starting material.

In a further preferred embodiment of the invention the material of the reactor 1, as described above, is toughened by means of yttrium oxide or magnesium oxide according to known techniques and processes.

In a further preferred embodiment of the disclosure the material of the reactor 1, as described above, is 80/20 alumina-zirconia toughened by means of yttrium oxide or magnesium oxide according to known techniques and processes.

In a preferred embodiment of the disclosure, as already described above, the mixture of alumina-zirconia metal oxides is toughened with yttrium oxide or magnesium oxide so that the weight percentage of zirconia comprises yttrium oxide or magnesium oxide in a range from 3% to 8% molar with respect to the moles of zirconia.

The shell-and-tube reactor 1, inserted in a plant context such as that of a concentrated solar field, exploits the heat transfer fluid (HTF) coming from the parabolic mirrors moved at pressures that can vary between 1 and 20 barg. For these reasons, in a further preferred embodiment of the disclosure, the reactor 1, as described above, has a design pressure of the shell side ranging from 1 to 20 barg.

In a further preferred embodiment of the disclosure, the reactor 1, as described above, has a design pressure of the tube side ranging from 1 to 20 barg.

The present disclosure also relates to a redox process at a high temperature between 600° C. and 1800° C., such as for example those involved in the synthesis of fuels and chemicals with solar energy. In particular, this process is applicable in order to partially or totally decarbonize all thermochemical production processes by using renewable energy in favour of reducing fossil emissions in the production processes. These processes include the synthesis of methanol starting from carbon dioxide and water (with or without methane), the synthesis of hydrogen from water or via steam methane reforming (SMR), the synthesis of syngas from carbon dioxide and water (with or without methane as a reagent). Another process wherein a high-temperature redox is envisaged is the one for the production of methanol from methane/carbon dioxide/water or hydrogen from water/methane or hydrogen using only water after endothermically the reduction step has occurred spontaneously due to the effect of thermal energy on the material. One of the biggest contributions to the greenhouse effect comes from carbon dioxide and its significant increase in the atmosphere is the subject of mitigation actions at international level. In an attempt to manage and minimize the production of CO₂ from anthropogenic activities, attempts have been made, in recent years, to use the same carbon dioxide where it is produced, avoiding flaring in oil fields. Many efforts have been made in recent years to develop processes that convert CO₂ into other products or into energy carriers, for example into methanol for use in motor vehicles or as a solvent or reagent. It should be remembered that methanol, compared to petrol, has a higher octane number, burns more easily and has a higher latent heat of evaporation. For these reasons, greater energy efficiency of the engine and a reduction in gaseous emissions (HC, NOₓ) can be obtained from its use. Unfortunately, the high thermodynamic stability of carbon dioxide entails a consequent high energy in order to be able to transform it into other products. The chemical transformation into syngas, a mixture of CO and H₂, is one of the most studied ways in order to be able to produce methanol. Industrially, syngas is synthesized primarily from fossil sources of natural gas or coal via steam reforming, combined steam reforming, catalytic and non-catalytic partial oxidation. In order to be able to produce syngas from carbon dioxide, it is important to have an abundant and inexpensive energy source available to carry out the endothermic reactions of CO₂ valorisation. Is the renewable factor added, then the concentrated solar power becomes the preferred choice. In this perspective, a pathway of thermochemical transformation of the carbon dioxide and water based on a metal oxide MO is being developed which performs a two-stage redox cycle as shown in the following diagram:

Reduction: MOOx→MOred+O₂ (endothermic)

Oxidation: MOred+CO₂→MOox+CO (exothermic)

MOred+H₂O→MOox+H₂ (exothermic)

The redox reaction comprises:
the thermal reduction of the metal oxide at high temperatures with oxygen release
the oxidation of the reduced metal at lower temperatures by carbon dioxide and/or water or mixtures thereof with the consequent production of CO, hydrogen or syngas

In this way, by carrying out reduction and oxidation cycles in series, it is possible to produce syngas for application purposes. One of the metal oxides studied is cerium oxide (IV) (CeO₂) where the reduction occurs spontaneously at about 1300-1500° C. while the oxidation can occur at the same temperature or at temperatures around 600-900° C. In general, the reduction is carried out in a partial manner to avoid the collapse of the oxide structure with consequent non-reproducibility of the phenomena. In practice, the Ce (IV) is not brought to the Ce (III) (Ce₂O₃) state, but a change is defined in the stoichiometry of the oxide & defined by:

$${CeO}_{( 2 - δ )} δ = [ - ( Δ m \times MWceria ) / ( ms \times MWoxygen ) ]$$

where MW ceria is the molecular weight of ceria, MW oxygen is the molecular weight of oxygen while ms is the mass of the test sample and Δm is its mass change during reduction. In the redox cycle, the necessary energy can be provided by a concentrated solar field or another form of thermal renewable energy. A different approach is to use a chemical agent that aids in the reduction of cerium oxide, reducing the amount of energy involved, that is, reducing it at temperatures lower than 1300° C., for example around 900-1200° C. The decrease in the energy specifications in this redox phase allows the use of a solar field having a lower power and therefore with less initial and operational investments. The use of temperatures lower than 1300° C. also allows to have a less critical reaction system with advantages from the realization point of view.

As a reducing agent, methane can be used according to the following scheme called hybrid cycle:

MOox reduction: 3CH₄+3/2O₂→3CO+6H₂

MOred oxidation: 2H₂O+CO₂−3/2O₂→CO+2H₂

Overall reaction: 3CH₄+2H₂O+CO₂→4CO+8H₂

The oxygen involved in the reactions is the one formally given/acquired by the ceria in the redox cycle. In this way 1 mole of CO₂ is used with 3 moles of CH₄ and 2 moles of water producing 4 moles of syngas with a H₂/CO ratio equal to 2. This ratio is the stoichiometric required for the conversion of syngas into methanol:

2H₂+CO→CH₃OH

The hybrid scheme produces 25% of the syngas via carbon dioxide. Since methane in reforming is also burned to provide the process with energy with consequent co-production of CO₂, the hybrid cycle appears as an environmentally friendly and renewable system in methanol production. Similarly to what has been previously reported, the hybrid system can be used to produce hydrogen using only water in the oxidation step (with hydrogen formation) and adding a further step to convert the CO produced by methane into another hydrogen via water gas shift.

The complete scheme for the redox production of hydrogen is as follows:

CH₄+½O₂↔2H₂+CO ceria reduction

H₂O+½O₂↔H₂ ceria oxidation

CO+2H₂O↔H₂+CO₂ water gas shift

CH₄+2H₂O↔4H₂+CO₂ final reaction

Alternatively, with redox materials other than cerium oxide or with the same cerium oxide but doped with metals or surface modified, it can be assumed that the reduction reaction can take place at T lower than 1300-1500° C. and in any case higher than 600° C. for which a redox cycle would be represented as follows:

MOox reduction: MOox+heat→MOred+½O₂

MOred oxidation: MOred+H₂O→MOOx+H₂

Overall reaction: H₂O→½O₂+8H₂

In this case, methane is no longer used, but only water as a reagent.

The availability of shell-and-tube reactor 1 as described above makes possible high temperature redox reactions by combining them with the use of renewable sources such as the solar power. The present disclosure therefore relates to a high-temperature redox process comprising the following steps:
providing a shell- and tube-reactor 1 according to any one of the preferred embodiments described above;
circulating a first heat transfer fluid on the shell side of shell-and-tube reactor 1, the heat transfer fluid having a temperature at the inlet to the reactor 1 ranging from 600° C. to 1800° C., the first heat transfer fluid comprising water or carbon dioxide or mixtures thereof;
circulating a second fluid on the tube side of the shell-and-tube reactor 1;
starting the redox reaction of the second fluid inside the shell-and-tube reactor 1 through absorption, by the second fluid, of heat released from the first heat transfer fluid.

In a preferred configuration in the described redox process the second fluid comprises carbon dioxide and water or only water and optionally methane.

In a further preferred configuration in the described redox process the second fluid comprises methane and water.

As described above, the process subject-matter of the present disclosure can make use of the presence of a redox material or even said catalyst for the redox reaction.

In a further preferred configuration, the redox process described above comprises the step of providing, inside the tube bundle of the reactor 1, a redox catalyst. This catalyst of the redox reaction is preferably a metal oxide and, more preferably, Cerium oxide or chemically or surface modified forms thereof.

The device of the present disclosure thus conceived is susceptible in any case to many modifications and variants, all falling within the same inventive concept; furthermore, all details can be replaced by equivalent technical elements.

The scope of protection of the disclosure is therefore defined by the appended claims.

1. A shell-and-tube reactor suited to be used at temperatures ranging from 600° C. to 1800° C., comprising a plurality of tubes and a shell, for the heat exchange between a first hot heat transfer fluid circulating on the shell side and a second fluid circulating on the tube side, the reactor comprising:
a building material that is a mixture of alumina-zirconia ZTA metal oxides;
the shell side has an outer surface that has a surface roughness ranging from 0.01 mm to 1 mm;
the shell side has an inner surface that has a surface roughness ranging from 0.01 mm to 1 mm;
the shell side has material that has an average grain diameter ranging from 0.15 mm to 10 mm, an average porosity ranging from 0.01% to 5% and an average pore diameter ranging from 10 nm to 0.2 mm.

2. The shell-and-tube reactor according to claim 1, wherein:
the outer surface of the shell side has a surface roughness ranging from 0.05 mm to 0.5 mm;
the inner surface of the shell side has a surface roughness ranging from 0.05 mm to 0.5 mm; and
the material of the shell side has an average grain diameter ranging from 0.3 mm to 5 mm, an average porosity ranging from 0.01% to 0.5% and an average pore diameter ranging from 50 nm to 0.1 mm.

3. The shell-and-tube reactor 1 according to claim 1, wherein:
the outer surface of the tubes has a surface roughness ranging from 10 mm to 250 mm;
the inner surface of the tubes has a surface roughness ranging from 10 mm to 250 mm; and
the material of the tube side has an average grain diameter ranging from 0.01 mm to 0.5 mm, an average porosity ranging from 0.01% to 5% and an average pore diameter ranging from 0.1 mm to 10 mm.

4. The shell-and-tube reactor according to claim 3, wherein:
the outer surface of the tubes has a surface roughness ranging from 40 mm to 120 mm;
the inner surface of the tubes has a surface roughness ranging from 40 mm to 120 mm; and
the material of the tube side has an average grain diameter ranging from 0.05 mm to 0.25 mm, an average porosity ranging from 0.01% to 0.5% and an average pore diameter ranging from 0.2 mm to 2 mm.

5. The shell-and-tube reactor according to claim 1, wherein the building material is a mixture of alumina-zirconia ZTA metal oxides with weight percentages ranging from 95/5 to 70/30.

6. The shell-and-tube reactor according to claim 1, wherein the mixture of ZTA alumina-zirconia metal oxides is toughened with yttrium oxide or magnesium oxide.

7. The shell-and-tube reactor according to claim 6, wherein the building material is a mixture of alumina-zirconia ZTA metal oxides with weight percentages ranging from 95/5 up to 70/30 toughened with yttrium oxide or magnesium oxide so that the weight percentage of zirconia comprises yttrium oxide or magnesium oxide ranging from 3% to 8% molar with respect to the moles of zirconia.

8. The shell-and-tube reactor 1 according to claim 7, wherein the building material is an 80/20 mixture of alumina-zirconia ZTA metal oxides toughened with yttrium oxide or magnesium oxide so that the weight percentage of zirconia comprises yttrium oxide or magnesium oxide ranging 3% to 8% molar with respect to the moles of zirconia.

9. The shell-and-tube reactor according to claim 1, wherein the design pressure of the shell side ranges from 1 to 20 barg.

10. The shell-and-tube reactor according to claim 1, wherein the design pressure of the tube side ranges from 1 to 20 barg.

11. High-temperature redox process comprising the following steps:
providing a shell-and-tube reactor according to claim 1;
circulating a first hot heat transfer fluid on the shell side of shell-and-tube reactor, the first heat transfer fluid having a temperature, at the inlet of the reactor, ranging from 600° C. to 1500° C., the first heat transfer fluid comprising water or carbon dioxide or mixtures thereof;
circulating a second fluid on the tube side of the shell-and-tube reactor; and
starting the redox reaction of the second fluid inside the tube of shell-and-tube reactor through absorption, by the second fluid, of heat released from the first hot heat transfer fluid.

12. The redox process according to claim 11, wherein the second fluid comprises carbon dioxide and water or only water and, optionally, methane.

13. The redox process according to claim 11, wherein the second fluid comprises methane and water.

14. The redox process according to claim 11, wherein the step of providing, inside the shell-and-tube reactor (1), has a redox catalyst.

15. The redox process according to claim 14, wherein the redox catalyst is a metal oxide.

16. The redox process according to claim 15, wherein the redox catalyst is cerium oxide.
